(19) United States
(12) Patent Application Publication
(10) Pub. No.: US 2010/0007573 A1
(43) Pub. Date: Jan. 14, 2010

(54) MULTIBEAM ANTENNA

(76) Inventors: Akio Kuramoto, Minato-ku (JP); Hiroyuki Yusa, Minato-ku (JP)

Correspondence Address: SUGHRUE MION, PLLC, 2100 PENNSYLVANIA AVENUE, N.W., SUITE 800, WASHINGTON, DC, 20037, US

(21) Appl. No.: 12/305,277

(22) PCT Filed: Apr. 9, 2008
(86) PCT No.: PCT/JP2008/056997

§ 371 Date: Dec. 17, 2008

(30) Foreign Application Priority Data
Apr. 10, 2007 (JP) 2007 103021

(51) Int. Cl. H01Q 25/00; H01Q 21/00

(52) U.S. Cl. 343/843; 343/893

(57) ABSTRACT

An antenna having two beams low in correlation and effective for MIMO is provided.

The antenna includes a first array antenna and a second array antenna. The first array antenna and the second array antenna have directivities different in direction, respectively. A maximum radiation direction of a combined beam from the first array antenna is oriented to a direction of θ1. A maximum radiation direction of a combined beam from the second array antenna is oriented to a direction of θ2 corresponding to a null point of the combined beam from the first array antenna.

### TECHNICAL FIELD

The present invention relates to a multibeam antenna and particularly relates to a multibeam antenna employed in an MIMO (Multiple Input Multiple Output) wireless technique or the like.

### BACKGROUND ART

Communication services using the MIMO technique such as WiMAX (Worldwide Interoperability for Microwave Access) are currently about to start. The MIMO technique is a technique for receiving many radio waves passing through a plurality of propagation paths, accelerating transmission rate, and improving communication quality. With the MIMO technique, two or more antennas are employed and greater effect can be produced if correlation between the antennas to be used is lower.

In a possible wireless service using the WiMAX, if a communication is to be held between a base station and a terminal and the terminal is located in an apartment or the like, arrival directions of radio waves from the base station normally concentrate on a direction of window side (since attenuation by many indoor walls is high in a direction of non-window side). In this way, if the arrival directions are almost set, it is optimal to use the two antennas having low correlation to each other and directivities oriented in the set direction.

Patent Document 1: Japanese Patent Application Laid-Open No.

### DISCLOSURE OF THE INVENTION

### Problems to be Solved by the Invention

The Patent Document 1 describes the invention in which a main lobe has a predetermined angle and two side lobes that are small beams are arranged bilaterally symmetrically. However, an angle of one null point does not always coincide with that of the other main lobe.

Generally, if wireless communication is to be held and the arrival direction of radio waves is almost known, two antennas are employed when a terminal is used in such a location as an apartment where external radio waves arrive overwhelmingly from a window direction and diversity technique or the MIMO (Multiple Input Multiple Output) technique is used in the communication. Preferably, the two antennas are as low in correlation as possible and as compact as possible.

The antennas employed in the communication using the MIMO technique are two monopole antennas or dipole antennas omnidirectional in azimuth orientation and arranged to be aligned. With this method, the two antennas are completely identical in directivity. Due to this, if the two antennas are disposed at short distance, the correlation between the two antennas cannot be made sufficiently low. As a result, MIMO transmission effect can be attained only insufficiently.

FIG. 16 shows an example of antennas according to a related technique. Monopole antennas 1001 and 1002 are arranged on an upper surface of a terminal device 1000 and omnidirectional radiation patterns 1011 and 1012 are formed around the antennas 1001 and 1002, respectively. In such a case, if the two antennas are disposed at short distance, then the correlation between the antennas cannot be made sufficiently low and the MIMO transmission effect can be attained only insufficiently because the two antennas are completely identical in directivity.

Furthermore, if the two antennas are employed, the correlation becomes lower as the two antennas are arranged to be farther from each other. This disadvantageously makes the device including the two antennas large in size. If the two antennas are arranged to be closer to each other, the device including the antennas is made smaller in size but the correlation between the antennas is disadvantageously higher.

It is an object of the present invention to provide an antenna having two beams low in correlation and effective for MIMO in these circumstances. According to the present invention, there is provided a multibeam antenna including a first array antenna and a second array antenna, wherein the first array antenna and the second array antenna have directivities in different direction from each other, a maximum radiation direction of a combined beam from the first array antenna is oriented to θ1 direction, and a maximum radiation direction of a combined beam from the second array antenna is oriented to θ2 direction corresponding to a null point of the combined beam from the first array antenna.

### ADVANTAGES OF THE INVENTION

The multibeam antenna according to the present invention is constituted by two array antennas, and is characterized in that the two array antennas have directivities for providing maximum gains in different directions, respectively, and the antenna has two beams and two feeding units so that a direction in which a radiation level of the directivity of the other array antenna becomes maximum coincides with a first null direction (direction in which a radiation level becomes minimal first from a main beam) of the directivity of one array antenna.

By so constituting, two antenna beams formed are quite low in correlation and arranged in proximate locations. Due to this, the antennas can be constituted to be quite compact. Further, if the antennas are employed in communication using the diversity technique or the MIMO technique, line level can be made stable and line quality and transmission rate can be improved.

### BRIEF DESCRIPTION OF THE DRAWINGS

FIG. 1 is a configuration diagram of a multibeam antenna according to a first embodiment of the present invention.

FIG. 2 is an explanatory diagram of setting of orientation of a main lobe.

FIG. 3 is a second explanatory diagram of setting of orientation of the main lobe.

FIG. 4 is a configuration diagram of a multibeam antenna according to a second embodiment of the present invention.

FIG. 5 is a configuration diagram of a multibeam antenna according to a third embodiment of the present invention.

FIG. 6A is a configuration diagram of a multibeam antenna according to a fourth embodiment of the present invention.

FIG. 6B is a radiation pattern view of the multibeam antenna according to the fourth embodiment of the present invention.

FIG. 7 is a configuration diagram of a multibeam antenna according to a fifth embodiment of the present invention.

FIG. 8 is a configuration diagram of a multibeam antenna according to a sixth embodiment of the present invention.

FIG. 9 is a configuration diagram of a multibeam antenna according to a seventh embodiment of the present invention.

FIG. 10 is a configuration diagram of a multibeam antenna according to an eighth embodiment of the present invention.

FIG. 11 is a configuration diagram of a multibeam antenna according to a ninth embodiment of the present invention.

FIG. 12 is a configuration diagram of a multibeam antenna according to a tenth embodiment of the present invention.

FIG. 13 is a configuration diagram of a multibeam antenna according to an eleventh embodiment of the present invention.

FIG. 14 is a configuration diagram of a multibeam antenna according to a twelfth embodiment of the present invention.

FIG. 15 is a configuration diagram of a multibeam antenna according to a thirteenth embodiment of the present invention.

FIG. 16 is a diagram showing an example of antennas according to a related technique.

### DESCRIPTION OF REFERENCE SYMBOLS

1, 2, 3, 4 Antenna
10 Array antenna A
20 Array antenna B
11, 21, 31, 41, 51, 61 Feeder

### BEST MODE FOR CARRYING OUT THE INVENTION

Best mode for carrying out the present invention will be described hereinafter in detail with reference to the drawings.

1) A multibeam antenna according to the present invention is configured to include an array antenna including antennas of M1×N1 elements and an array antenna including antennas of M2×N2 elements, wherein the two array antennas have directivities for providing maximum gains in different directions, respectively, a maximum radiation direction of a combined beam from the array antenna having the M1×N1 elements for providing a maximum gain is set to a direction of (θ1, φ1) on a polar coordinate system, and a maximum radiation direction of a combined beam from the array antenna having the M2×N2 elements is oriented to a direction of an arbitrary first null point (θ2, φ2) near the (θ1, φ1).

In the maximum radiation direction (θ2, φ2) of the combined beam from the array antenna having the M2×N2 elements, a null point of the combined beam from the array antenna having the M1×N1 elements is present. Due to this, the correlation between the beams from the two array antennas is quite low and efficient MIMO communication can be held by using the two antennas.

2) As a second method, a multibeam antenna is configured to include two array antennas each including antennas of M1×N1 elements, wherein the two array antennas have directivities for providing maximum gains in different directions, respectively, a maximum radiation direction of a combined beam from the first array antenna having the M1×N1 elements for providing a maximum gain is set to a direction of (θ1, φ1) on a polar coordinate system, and a maximum radiation direction of a combined beam from the second array antenna having the M1×N1 elements for providing a maximum gain is oriented to a direction of an arbitrary first null point (θ2, φ2) near the (θ1, φ1).

In this method, M1 is set equal to M2, i.e., M1=M2 and N1 is set equal to N2, i.e., N1=N2 in the above-stated 1). With this method, a null point of the combined beam from the first array antenna is present in the maximum radiation direction (θ2, φ2) of the combined beam from the second array antenna, and a null point of the combined beam from the second array antenna is present in the maximum radiation direction (θ1, φ1) of the combined beam from the first array antenna. Due to this, the correlation between the beams from the two array antennas is far lower than that of 1) and efficient MIMO communication can be held by using the two antennas.

3) As a third method, a multibeam antenna is configured to include an array antenna including antennas of M elements arranged on a Z axis of polar coordinates and an N element array antenna including antennas of N elements arranged on the Z axis of the polar coordinates or on a line parallel to the Z axis, wherein the two array antennas have directivities for providing maximum gains in different directions, respectively, a maximum radiation direction of a combined beam from the array antenna having the M elements for providing the maximum gain is set to a direction of (θ1, φ) on a polar coordinate system, and a maximum radiation direction of a combined beam from the array antenna having the N elements is oriented to a direction of an arbitrary first null point (θ2, φ) near the (θ1, φ).

In the maximum radiation direction (θ2, φ) of the combined beam from the array antenna having the N elements, a null point of the combined beam from the array antenna having the M elements is present. Due to this, the correlation between the beams from the two array antennas is quite low and efficient MIMO communication can be held by using the two antennas.

4) As a fourth method, a multibeam antenna is configured to include two array antennas each including antennas of M elements arranged on a Z axis of polar coordinates, wherein the two array antennas have directivities for providing maximum gains in different directions, respectively, a maximum radiation direction of a combined beam from the first array antenna having the M elements for providing a maximum gain is set to a direction of (θ1, φ) on a polar coordinate system, and a maximum radiation direction of a combined beam from the second array antenna having the M elements for providing a maximum gain is oriented to a direction of an arbitrary first null point (θ2, φ) near the (θ1, φ).

In this method, M is set equal to N, i.e., M=N in the above-stated 3). With this method, a null point of the combined beam from the first array antenna is present in the maximum radiation direction (θ2, φ) of the combined beam from the second array antenna, and a null point of the combined beam from the second array antenna is present in the maximum radiation direction (θ1, φ) of the combined beam from the first array antenna. Due to this, the correlation between the beams from the two array antennas is far lower than that of 3) and efficient MIMO communication can be held by using the two antennas.

5) A fifth method is a more practical method and corresponds to an instance in which M is two elements in 4). A multibeam antenna is configured to include a first array antenna including an antenna 1 and an antenna 2 and a second array antenna including an antenna 3 and an antenna 4. The two array antennas have directivities for providing maximum gains in different directions, respectively. An element distance between the antennas 1 and 2 is equal to an element distance between the antennas 3 and 4. A line on which the antennas 1 and 2 are arranged and a line on which the antennas 3 and 4 are arranged have an identical relationship or a parallel relationship. A maximum radiation direction of a combined beam from the antennas 1 and 2 is a perpendicular direction to the line, that is, a direction of θ1 degrees from a broadside direction of the array arrangement, and a direction of θ2 that is an angle of a first null point near the direction of θ1 degrees is a maximum radiation direction of a combined beam from the antennas 3 and 4.

With this method, similarly to 4), a null point of the combined beam from the array antenna including the antennas 1 and 2 is present in the maximum radiation direction θ2 of the combined beam from the array antenna including the antennas 3 and 4, and a null point of the combined beam from the array antenna including the antennas 3 and 4 is present in the maximum radiation direction θ1 of the combined beam from the array antenna including the antennas 1 and 2. Due to this, the correlation between the beams from the two array antennas is quite low and efficient MIMO communication can be held by using the two antennas.

In the above-stated case, if the element distance between the antennas 1 and 2 is equal to that between the antennas 3 and 4 and a normalized element distance is assumed as D (D=d/λ, where λ is a wavelength if an element distance is d) and θ1>θ2, a relationship among the θ1, the θ2, and the d is expressed as

sin{(θ1−θ2)/2}=1/(4D).

6) A sixth method is a further simplified method of the fifth method 5). Namely, a multibeam antenna is configured to include a first array antenna including antennas 1 and 2 and a second array antenna including antennas 3 and 4, wherein the two array antennas have directivities for providing maximum gains in different directions, respectively, an element distance between the antennas 1 and 2 is equal to an element distance between the antennas 3 and 4, and a line on which the antennas 1 and 2 are arranged and a line on which the antennas 3 and 4 are arranged have an identical relationship or a parallel relationship. Power is fed to the antennas 1 and 2 in the same phase and power is also fed to the antennas 3 and 4 in the same phase. A maximum radiation direction of the array antenna including the antennas 1 and 2 shifts from a perpendicular direction of the line of the array (a broadside direction of the array) by a θ1 degrees on a plane including the line, and a maximum radiation direction of the array antenna including the antennas 3 and 4 shifts from a perpendicular direction of the line of the array (a broadside direction of the array) by a −θ1 degrees on a plane including the line. At this time, the maximum radiation direction −θ1 of the array antenna including the antennas 3 and 4 is a null direction of the array antenna including the antennas 1 and 2, and the maximum radiation direction θ1 of the array antenna including the antennas 1 and 2 is a null direction of the array antenna including the antennas 3 and 4.

At this time, the element distance between the antennas 1 and 2 is set equal to that between the antennas 3 and 4. A phase difference between power feeding to the array antenna including the antennas 1 and 2 and power feeding to the array antenna including the antennas 3 and 4 is π/2 irrespectively of a value of the element distance.

The multibeam antenna according to the present invention is an antenna employed in communication using the MIMO technique. In recent years, the MIMO technique has been adopted in a communication system using the WiMAX technique. By using the multibeam antenna according to the present invention, it is possible to make effective use of the MIMO technique.

According to the MIMO, a plurality of antennas is used on a transmitting side and a receiving side and transmission is performed using a plurality of different propagation paths in a multiple propagation path space having many multipath, thereby accelerating transmission rate. At this time, it is preferable that a correlation among a plurality of antennas used on the transmitting side and the receiving side is low. For example, if two antennas are used on the receiving side, the two antennas are disposed to be as away as possible, thereby making it possible to reduce the correlation.

The multibeam antenna according to the present invention is constituted by two array antennas having N elements, and is characterized in that the two array antennas have directivities for providing maximum gains in different directions, respectively, and the antenna has two beams and two feeding units so that a direction in which a radiation level of the directivity of the other array antenna becomes maximum coincides with a first null direction (direction in which a radiation level becomes minimal first from a main beam) of the directivity of one array antenna.

By so constituting, two antenna beams formed are quite low in correlation and arranged in proximate locations. Due to this, the antennas can be constituted to be quite compact.

If the two antennas having low correlation are employed in communication using the diversity technique or the MIMO technique, line level can be made stable and line quality and transmission rate can be improved.

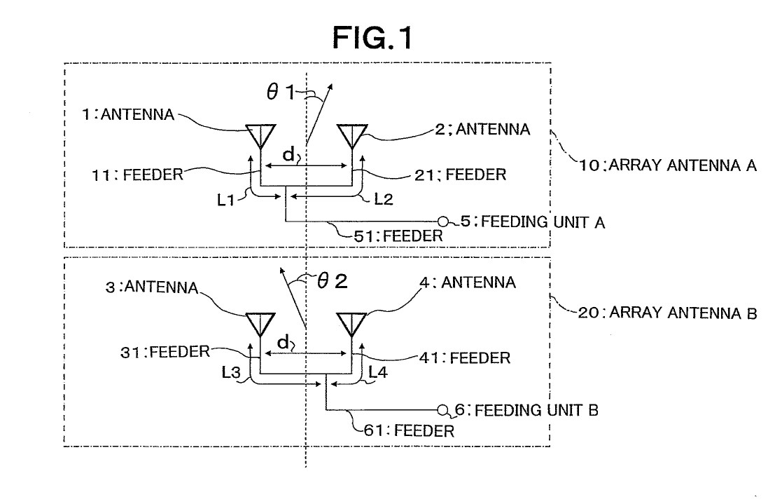

FIG. 1 is a configuration diagram of a multibeam antenna according to a first embodiment of the present invention. An array antenna A 10 is configured to include an antenna 1, an antenna 2, a feeder 11, a feeder 21, a feeder 51, and a feeding unit A 5. Likewise, an array antenna B 20 is configured to include an antenna 3, an antenna 4, a feeder 31, a feeder 41, a feeder 61, and a feeding unit B 6.

The feeder 11 having a length of L1 and the feeder 21 having a length of L2 are connected to the antennas 1 and 2, respectively, the other ends of the both feeders are joined and connected together, connected to the feeder 51, and reach the feeding unit A 5. Likewise, the feeder 31 having a length of L3 and the feeder 41 having a length of L4 are connected to the antennas 3 and 4, respectively, the other ends of the both feeders are joined and connected together, connected to the feeder 61, and reach the feeding unit B 6.

It is to be noted that the antennas 1 and 2 are arranged on a line horizontal to a paper sheet, the antennas 3 and 4 are similarly arranged on a line horizontal to the paper sheet, and that the array antennas A and B are arranged on parallel lines or an identical line.

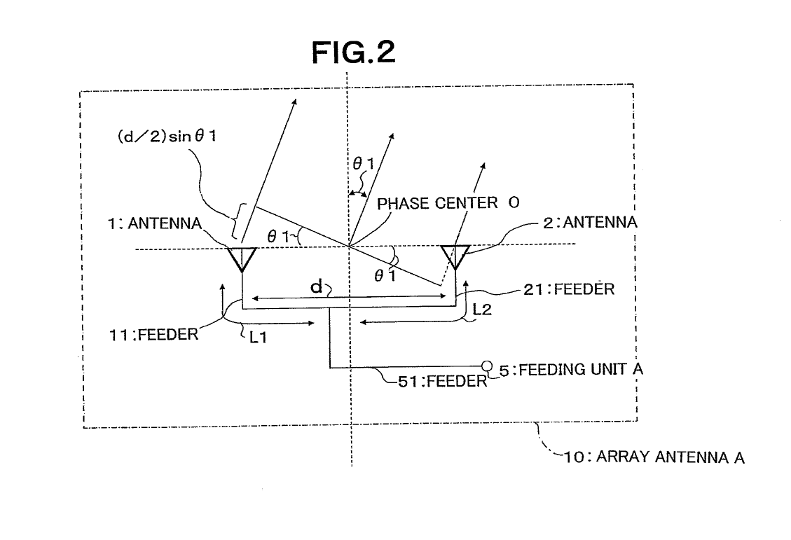

A direction of a main beam from the array antenna A 10, that is, a maximum radiation direction providing maximum gain is set to a direction perpendicular to the line on which the array A 10 is arranged, that is, a direction inclined at θ1 degree with respect to a broadside direction. In this case, to orient a main lobe to the θ1 degree direction, the lengths L1 and L2 of the feeders connected to the antennas 1 and 2 are adjusted. FIG. 2 is an explanatory view for the adjustment. Providing that an element distance between the antennas 1 and 2 is d, it is necessary to make radio waves radiated from the antennas 1 and 2 equal in phase in the θ1 direction in order to orient a main lobe to the θ1 direction. A path length of the antenna 1 delays by (d/2)sin θ1 and a path length of the antenna 2 advances by (d/2)sin θ1 with respect to phase center O. This spatial path length (d/2)sin θ1 can be converted into an electric phase angle by multiplying the path length (d/2)sin θ1 by 2π/λ (λ: wavelength). Accordingly, if the following excitation phases are given to the antennas 1 and 2, respectively, the beam having maximum radiation in the θ1 direction can be formed.

Excitation phase of antenna 1=+(2π/λ)×(d/2)×sin θ1 (1)

Excitation phase of antenna 2=−(2π/λ)×(d/2)×sin θ1 (2)

Further, a relative phase difference 61 of the antenna 1 to the antenna 2 is expressed as follows based on the above Equations (1) and (2).

In the Equations (1) and (2), symbol + means advancing phase and symbol − means delaying phase.

$$\begin{matrix}δ 1 = ( Excitation phase of antenna 1 ) - \\ ( Excitation phase of antenna 2 ) \\ = ( 2 π / λ ) \times ( d / 2 ) \times sin θ 1 - ( - ( 2 π / λ ) \times ( d / 2 ) \times sin θ 1 ) \\ = ( 2 π d / λ ) \times sin θ 1\end{matrix} \qquad ( 3 )$$

It, therefore, suffices to set an electric length of L2-L1 to 61 in FIG. 1. Field intensity at an arbitrary angle θ of the array antenna A 10 having the maximum radiation direction that is the θ1 direction is derived from the above. If an excitation amplitude of the antenna 1 is E1 and that of the antenna 2 is E2, a combined electric field Et1 of the array antenna A 10 is expressed as follows.

$$\begin{matrix}Et 1 = E 1 \times EXP ( - j \times ( 2 π / λ ) \times ( d / 2 ) \times \\ sin θ + j \times ( 2 π / λ ) \times ( d / 2 ) \times sin θ 1 ) + \\ E 2 \times EXP ( j \times ( 2 π / λ ) \times ( d / 2 ) \times \\ sin θ - j \times ( 2 π / λ ) \times ( d / 2 ) \times sin θ 1 ) \\ = E 1 \times EXP ( - j π d / λ ) \times ( sin θ - sin θ 1 ) ) + \\ E 2 \times EXP ( j π d / λ \times ( sin θ - sin θ 1 ) \\ = E 1 ( cos ( π d / λ \times ( sin θ - sin θ 1 ) ) - \\ j sin ( π d / λ \times ( sin θ - sin θ 1 ) ) ) + \\ E 2 ( cos ( π d / λ \times ( sin θ - sin θ 1 ) ) + \\ j sin ( π d / λ \times ( sin θ - sin θ 1 ) ) )\end{matrix}$$

In this case, if the excitation amplitudes of the antennas 1 and 2 are set equal, that is, E1=E2, the combined electric field Et1 is expressed as follows.

Et1=2×E1×cos(πd/λ×(sin θ−sin θ1))

Furthermore, if the element distance d is substituted by an element distance D (D=d/λ) normalized by wavelength, Et1 is expressed as follows.

$$\begin{matrix}Et 1 = 2 \times E 1 \times cos ( π \times λ D / λ \times ( sin θ - sin θ 1 ) ) \\ = 2 \times E 1 \times cos ( π D ( sin θ - sin θ 1 ) )\end{matrix} \qquad ( 4 )$$

The above explanation is similarly applied to the array antenna B 20 configured to include the antennas 3 and 4 shown in FIG. 1. In FIG. 1, to orient a main beam from the array antenna B 20 to a θ2 direction, the principle of FIG. 2 and the above explanation are applicable. Therefore, electric phases exciting the antennas 3 and 4 are expressed as follows.

Excitation phase of antenna 3=−(2π/λ)×(d/2)×sin θ2 (5)

Excitation phase of antenna 4=+(2π/λ)×(d/2)×sin θ2 (6)

Further, a relative phase difference δ2 of the antenna 3 to the antenna 4 is expressed as follows.

$$\begin{matrix}δ 2 = ( Excitation phase of antenna 4 ) - \\ ( Excitation phase of antenna 3 ) \\ = ( 2 π / λ ) \times ( d / 2 ) \times sin θ 2 - ( - ( 2 π / λ ) \times ( d / 2 ) \times sin θ 2 ) \\ = ( 2 π d / λ ) \times sin θ 2\end{matrix} \qquad ( 7 )$$

It, therefore, suffices to set an electric length of L4-L3 to 62 in FIG. 1.

Field intensity at the arbitrary angle θ of the array antenna B 20 having the maximum radiation direction that is the θ2 direction is derived from the above. If an excitation amplitude of the antenna 3 is E3 and that of the antenna 4 is E4, a combined electric field Et2 of the array antenna B 20 is expressed as follows.

$$\begin{matrix}Et 2 = E 3 \times EXP ( - j \times ( 2 π / λ ) \times ( d / 2 ) \times \\ sin θ - j \times ( 2 π / λ ) \times ( d / 2 ) \times sin θ 2 ) + \\ E 4 \times EXP ( j \times ( 2 π / λ ) \times ( d / 2 ) \times \\ sin θ + j \times ( 2 π / λ ) \times ( d / 2 ) \times sin θ 2 ) \\ = E 3 \times EXP ( - j π d / λ ) \times ( sin θ - sin θ 2 ) ) + \\ E 4 \times EXP ( j π d / λ \times ( sin θ + sin θ 2 ) \\ = E 3 ( cos ( π d / λ \times ( sin θ + sin θ 2 ) ) - \\ j sin ( π d / λ \times ( sin θ + sin θ 2 ) ) ) + \\ E 2 ( cos ( π d / λ \times ( sin θ + sin θ 2 ) ) + \\ j sin ( π d / λ \times ( sin θ + sin θ 2 ) ) )\end{matrix}$$

In this case, if the excitation amplitudes of the antennas 3 and 4 are set equal, that is, E3=E4, the combined electric field Et2 is expressed as follows.

Et2=2×E3×cos(πd/λ×(sin θ+sin θ2))

Furthermore, if the element distance d is substituted by an element distance D (D=d/λ) normalized by wavelength, Et2 is expressed as follows.

$$\begin{matrix}Et 2 = 2 \times E 3 \times cos ( π \times λ D / λ \times ( sin θ - sin θ 2 ) ) \\ = 2 \times E 3 \times cos ( π D ( sin θ - sin θ 2 ) )\end{matrix} \qquad ( 8 )$$

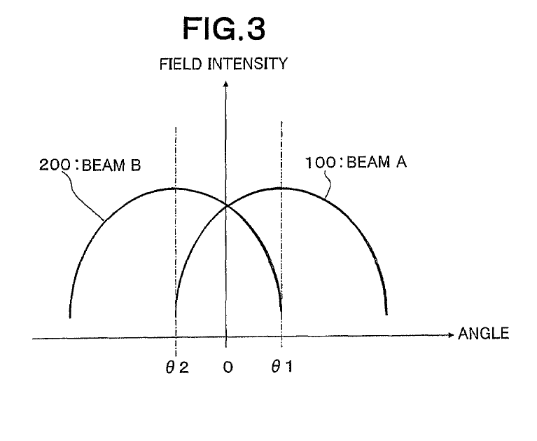

FIG. 3 is a second explanatory diagram of orientation of the main lobe. It is a directivity view in which a vertical axis indicates field intensity and a horizontal axis indicates an angle. A main beam radiated from the array antenna A 10 shown in FIGS. 1 and 2 is a beam A100 whereas a main beam radiated from the array antenna B 20 shown in FIG. 1 is a beam B200. To exhibit features of the multibeam antenna according to the present invention, it is necessary that the maximum radiation direction θ1 of the array antenna A 10 is a null direction of the array antenna B 20 and that the maximum radiation direction θ2 of the array antenna B 20 is a null direction of the array antenna A 10.

These settings are applied to the Equations of Et1 and Et2 and considered. The Et1 has the maximum radiation direction of θ1. A condition that the Et1 is null is as follows.

In Et1=2×E1×cos(πD(sin θ−sin θ1)),

πD(sin θ−sin θ1)=±(π/2)×(2k−1), where k=1, 2, 3 . . . K (natural number).

In FIG. 3, when a first point at left of θ1 is a null point, the following Equations are held.

πD(sin θ−sin θ1)=−π/2

(sin θ1−sin θ)=1/(2D) (9)

sin θ=sin θ1−1/(2D)

θ=sin⁻¹(sin θ1−1/(2D)) (10)

Accordingly, if θ2=sin⁻¹(sin θ1−1/(2D)), the multibeam antenna can be configured so that the maximum radiation direction θ1 of the array antenna A 10 is the null direction of the array antenna B 20 and that the maximum radiation direction θ2 of the array antenna B 20 is the null direction of the array antenna A 10.

For example, at D=0.5 and θ1=30 degrees, θ2=−30 degrees according to Equation (10). At θ2=−30 degrees, the excitation phase of the antenna 1 is +45 degrees according to the Equation (1), that of the antenna 2 is −45 degrees according to the Equation (2), that of the antenna 3 is −45 degrees according to the Equation (5), and that of the antenna 4 is +45 degrees according to the Equation (6).

As a second example, at D=0.5 and θ1=45 degrees, θ2=−17 degrees. At θ2=−17 degrees, the excitation phase of the antenna 1 is +63.6 degrees, that of the antenna 2 is −63.6 degrees, that of the antenna 3 is −26.3 degrees, and that of the antenna 4 is +26.3 degrees.

An instance in which the beams A100 and B200 are arranged symmetrically about the broadside direction of the arrays, that is, about θ=0 will be considered. In this instance, the following Equation is given according to the Equation (9).

(sin θ1−sin θ2)=1/(2D)

Furthermore, in this case, it is necessary to satisfy θ2=−θ1 as obvious from FIG. 3. Therefore, (sin θ1−sin θ2)=1/(2D) is rewritten as follows.

(sin θ1−sin(−θ1))=1/(2D)

2 sin θ1=1/(2D)

sin θ1=1/(4D)

θ1=sin⁻¹(1/(4D)) (11)

Moreover, this Equation is rewritten to the form of D=as expressed as follows.

D=1/(4 sin θ1) (12)

The relation of D=d/λ and the Equation (12) are assigned to the Equation (1) to make the Equation (1) simple as follows.

Excitation phase of antenna 1

$$= + ( 2 π / λ ) \times ( d / 2 ) \times sin θ 1 \\ = + ( 2 π / λ ) \times ( λ D / 2 ) \times sin θ 1 \\ = + π D \times sin θ 1 \\ = + π ( 1 / ( 4 sin θ 1 ) ) \times sin θ 1 \\ = + π / 4 \\ = + 45 degrees ( 13 ) \qquad ( 1 )$$

In this case, despite the element distance D, the excitation phase of the antenna 1 is +45 degrees according to the Equation (13). Likewise, the excitation phase of the antenna 2 is −45 degrees. Further, the excitation phases of the antennas 3 and 4 are −45 degrees and +45 degrees, respectively.

Therefore, in the example of the Equations (12) and (13), that is, in the instance in which the beams A100 and B200 are arranged in the broadside direction of the arrays, that is, arranged symmetrically about θ=0, at D=0.5, θ1=30 degrees, θ2=−30 degrees, the excitation phase of the antenna 1 is +45 degrees, the excitation phase of the antenna 2 is −45 degrees, the excitation phase of the antenna 3 is −45 degrees, the excitation phase of the antenna 4 is +45 degrees.

Likewise, at D=0.7, θ1=20.9 degrees, θ2=−20.9 degrees, the excitation phase of the antenna 1 is +45 degrees, the excitation phase of the antenna 2 is −45 degrees, the excitation phase of the antenna 3 is −45 degrees, the excitation phase of the antenna 4 is +45 degrees.

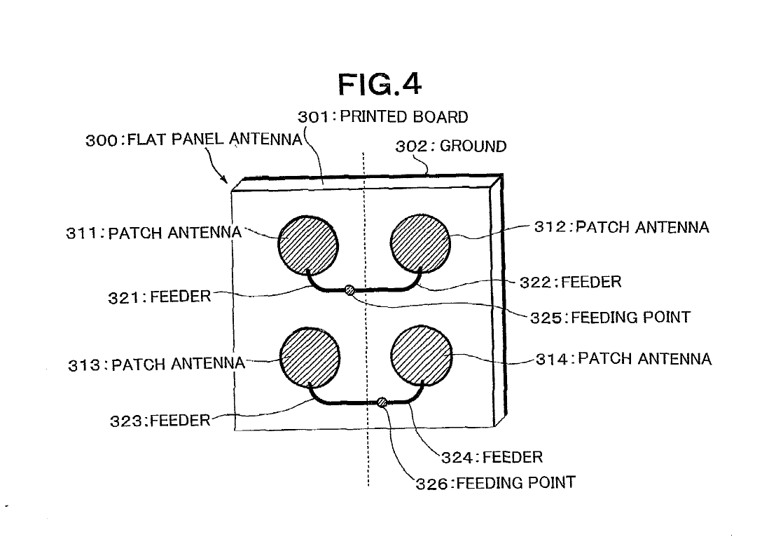

FIG. 4 is a configuration diagram of a multibeam antenna according to a second embodiment of the present invention. A flat panel antenna 300 is configured to include a printed board 301 having a conductor ground 302 provided on a rear surface. Patch antennas 311 to 314 are arranged on a front surface of the printed board 301 and feeders 321 to 324 of a microstrip line are connected to the patch antennas 311 to 314, respectively. The feeders 321 and 322 are connected to the patch antennas 311 and 312, respectively and combined at a feeding point 325. The relationship of length between the feeders 321 and 322 is similar to the relationship between L1 and L2 shown in FIG. 1 or 2. Likewise, the feeders 323 and 324 are connected to the patch antennas 313 and 314, respectively and combined at a feeding point 326. The relationship of length between the feeders 323 and 324 is similar to the relationship between L3 and L4 shown in FIG. 1. Coaxially central conductors of a connector are normally connected to the feeding points 325 and 326 from the rear surface of the printed board 301 to thereby feed power to the feeding points 325 and 326. Since power feeding to the feeding points 325 and 326 has a similar relationship shown in FIG. 1, two beams can be formed so that a first null point of the other antenna is present at a beam peak of one antenna pattern.

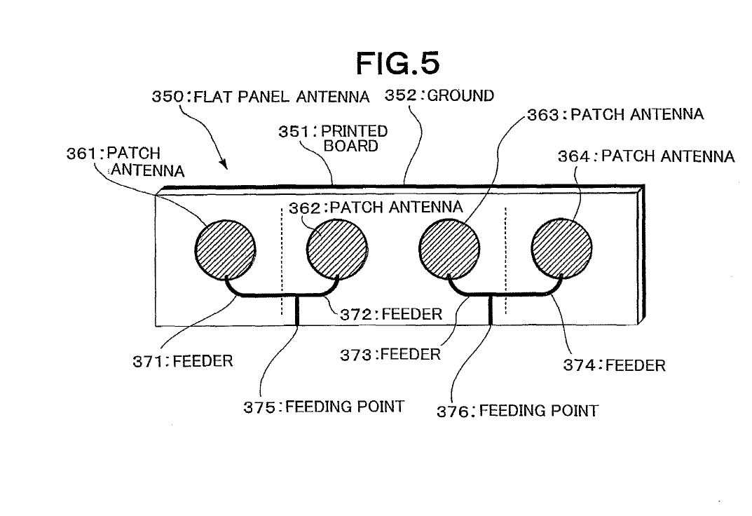

FIG. 5 is a configuration diagram of a multibeam antenna according to a third embodiment of the present invention. A flat panel antenna 350 is configured to include a printed board 351 having a conductor ground 352 provided on a rear surface. Patch antennas 361 to 364 are arranged on a front surface of the printed board 351 and feeders 371 to 374 of a microstrip line are connected to the patch antennas 361 to 364, respectively. The feeders 371 and 372 are connected to the patch antennas 361 and 362, respectively, are combined together, and reach a feeding point 375. The relationship of length between the feeders 371 and 372 is similar to the relationship between L1 and L2 shown in FIG. 1 or 2. Likewise, the feeders 373 and 374 are connected to the patch antennas 363 and 364, respectively, are combined together, and reach a feeding point 376. The relationship of length between the feeders 373 and 374 is similar to the relationship between L3 and L4 shown in FIG. 1. Coaxially central conductors of an SMA connector are connected to the feeding point 375 and 376 from the under surface of the printed board 351 to thereby feed power to the feeding points 375 and 376. Similarly to FIG. 4, since power feeding to the feeding points 375 and 376 has a similar relationship shown in FIG. 1, two beams can be formed so that a first null point of the other antenna is present at a beam peak of one antenna pattern.

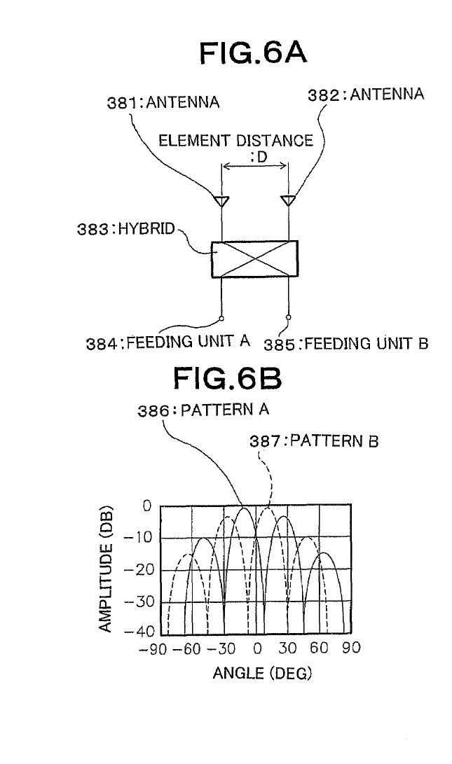

FIG. 6A is a configuration diagram of a multibeam antenna according to a fourth embodiment of the present invention. In the antenna configuration shown in FIG. 6A, antennas 381 and 382 are arranged to be apart from each other by an element distance d and connected to a hybrid circuit 383. The other two ports of the hybrid circuit 383 reach feeding units A 384 and B 385 located downward of the hybrid circuit 383, respectively. According to the description after the Equation (13), if excitation phases of the two antennas are +45 degrees and −45 degrees, respectively, that is, a phase difference is 90 degrees despite the element distance d between the two antennas, two beams can be formed so that a first null point of the other antenna is present at a beam peak of one antenna pattern. FIG. 6A shows an example of configuring this multibeam antenna using the hybrid circuit 383. The hybrid circuit 383 divides an RF signal fed from the feeding unit A 384 into two signals equal in amplitude and different in phase by 90 degrees and feeds the two signals to the antennas 381 and 382, respectively. In this case, the phase of the antenna 382 has a delay of 90 degrees with respect to that of the antenna 381. In this case, a pattern is a pattern A 386 (indicated by a dotted line) in a radiation pattern view of FIG. 6B. Likewise, the hybrid circuit 383 divides an RF signal fed from the feeding unit B 385 into two signals equal in amplitude and different in phase by 90 degrees and feeds the two signals to the antennas 381 and 382, respectively. In this case, the phase of the antenna 381 has a delay of 90 degrees with respect to that of the antenna 382. In this case, a pattern is a pattern B 387 (indicated by a solid line) as shown in FIG. 6B. Further, as shown in FIG. 6B, the two radiation patterns are formed so that a first null angle of the other pattern is an angle of a beam peak of one pattern.

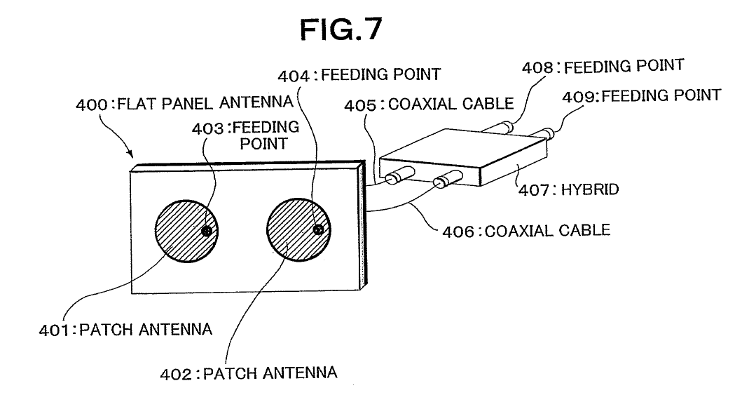

FIG. 7 is a configuration diagram of a multibeam antenna according to a fifth embodiment of the present invention. A flat panel antenna 400 configured to include a printed board is structured so that patch antennas 401 and 402 are arranged on a front surface and that coaxially central conductors of a connector are connected to feeding points 403 and 404 from a rear surface to thereby feed power to the feeding points 403 and 404. These feeding points are connected to a hybrid circuit 407 by coaxial cables 405 and 406, respectively. Feeding units 408 and 409 are arranged on the other two ports of the hybrid circuit 407, respectively. In this case, operation principle is similar to that shown in FIG. 6B and radiation patterns are formed so that a first null angle of the other pattern is an angle of a beam peak of one pattern.

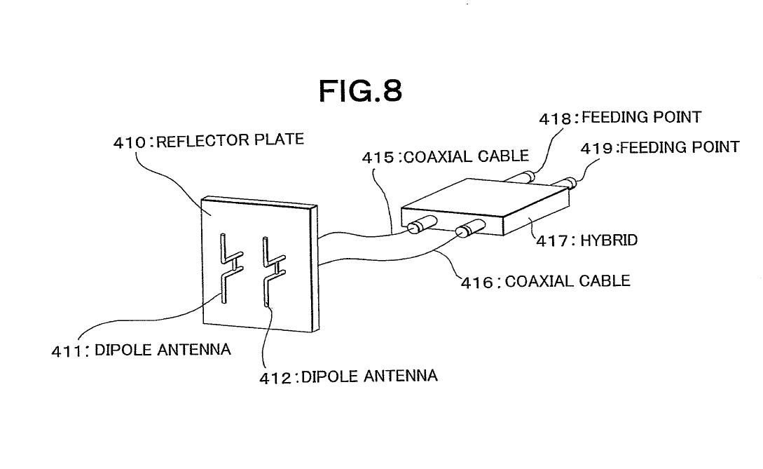

FIG. 8 is a configuration diagram of a multibeam antenna according to a sixth embodiment of the present invention. An antenna configured to include a metal reflector plate 410 and two dipole antennas 411 and 412 is connected to a hybrid circuit 417 by coaxial cables 415 and 416 in place of the flat panel antenna 400 shown in FIG. 7. Radiation patterns fed from feeding units 418 and 419 are formed so that a first null angle of the other pattern is an angle of a beam peak of one pattern similarly to FIG. 6B.

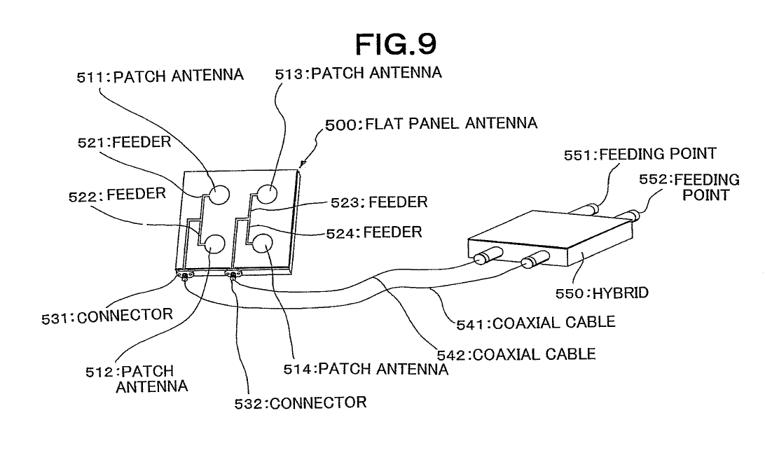

FIG. 9 is a configuration diagram of a multibeam antenna according to a seventh embodiment of the present invention. A flat panel antenna 500 is employed in place of the flat panel antenna 400 shown in FIG. 7. The flat panel antenna 500 configured to include a printed board is structured so that patch antennas 511 to 514 are arranged on an entire surface and so that feeders 521 to 524 of a microstrip line are connected to the patch antennas 511 to 514, respectively. The feeders 521 and 522 are connected to the patch antennas 511 and 512, respectively and connected to a connector 531. Lengths of the feeders 521 and 522 relate to a maximum radiation direction of an elevation surface of the flat panel antenna 500. Generally, if beams are radiated in a direction perpendicular to the flat panel antenna 500, the lengths of the feeders 521 and 522 are designed to be equal. If the beams shift from the perpendicular direction to an upward direction or a downward direction, the flat panel antenna 500 is designed while the principle of FIG. 2 is applied to the elevation surface. Likewise, the feeders 523 and 524 are connected to the patch antennas 513 and 514, respectively and connected to a connector 532. The relationship of length between the feeders 523 and 524 is similar to that between the feeders 521 and 522. Coaxial cables 541 and 542 are connected to the connectors 531 and 532, are connected to a hybrid circuit 550, and finally reach feeding units 551 and 552, respectively. Radiation patterns fed from the feeding units 551 and 552 are similar to those shown in FIG. 6B in an azimuth direction of the flat panel antenna 500 and formed so that a first null angle of the other pattern is an angle of a beam peak of one pattern.

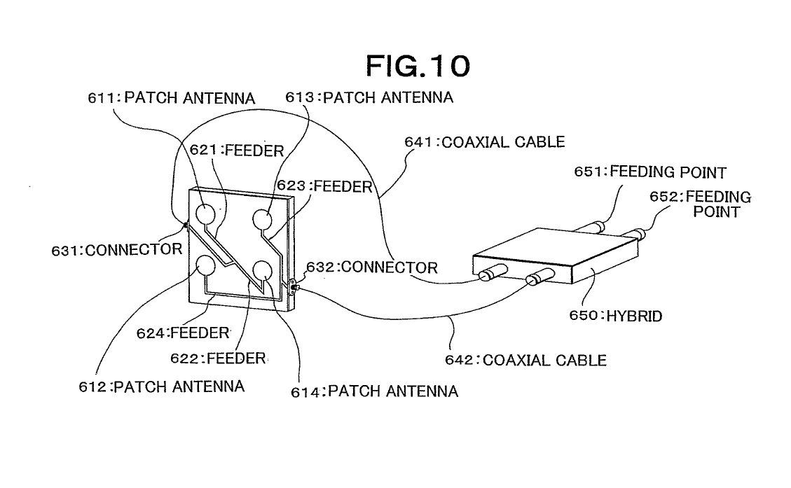

FIG. 10 is a configuration diagram of a multibeam antenna according to an eighth embodiment of the present invention. The antenna shown in FIG. 10 is configured so that arrangement of the patch antennas and the feeding circuit of the flat panel antenna shown in FIG. 9 is changed. Patch antennas 611 and 614 are arranged to be diagonal to each other and patch antennas 612 and 613 are arranged to be diagonal to each other. Feeders 621 and 622 are connected to the patch antennas 611 and 614, respectively and connected to a connector 631. Feeders 622 and 623 are connected to the patch antennas 612 and 613, respectively and connected to a connector 632. Furthermore, the feeders 621 and 622 are connected to a hybrid circuit 650 by a coaxial cable 641 and finally reach a feeding unit 651. The feeders 622 and 623 are connected to the hybrid circuit 650 by a coaxial cable 642 and finally reach a feeding unit 652. Radiation patterns fed from the feeding units 651 and 652 are similar to those shown in FIG. 6B in an azimuth direction and elevation direction of the flat panel antenna and formed so that a first null angle of the other pattern is an angle of a beam peak of one pattern.

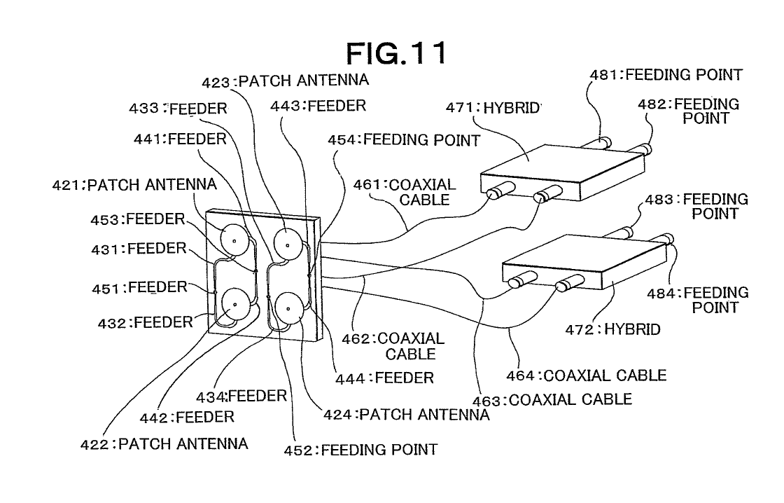

FIG. 11 is a configuration diagram of a multibeam antenna according to a ninth embodiment of the present invention. It can be understood that power is independently fed from horizontally and perpendicularly of the patch antennas of the flat panel antenna shown in FIG. 9 in principle. First, feeders 431 to 434 are connected from below to patch antennas 421 to 424, respectively so as to be able to radiate vertically polarized waves. The feeders 431 and 432 are combined together at the same length and the feeders 433 and 434 are combined together at the same length, and the feeders 431 and 432 and the feeders 433 and 434 reach feeding points 451 and 452, respectively. Likewise, feeders 441 to 444 are connected from right lateral side to the patch antennas 421 to 424, respectively so as to be able to radiate horizontally polarized waves. The feeders 441 and 442 are combined together at the same length and the feeders 443 and 444 are combined together at the same length, and the feeders 441 and 442 and the feeders 443 and 444 reach feeding points 453 and 454, respectively. Further, the feeding points 453 and 454 are connected to a hybrid circuit 471 by coaxial cables 461 and 462, respectively. The feeding points 453 and 454 are connected to a hybrid circuit 472 by coaxial cables 463 and 464, respectively. Finally, radiation patterns fed from the feeding unit 483 and 484 are similar to those shown in FIG. 6B in a vertically polarized wave patterns in an azimuth direction of the flat panel antenna and formed so that a first null angle of the other pattern is an angle of a beam peak of one pattern. Radiation patterns fed from the feeding unit 483 and 484 are similar to those shown in FIG. 6B in a horizontally polarized wave patterns in an azimuth direction of the flat panel antenna and formed so that a first null angle of the other pattern is an angle of a beam peak of one pattern.

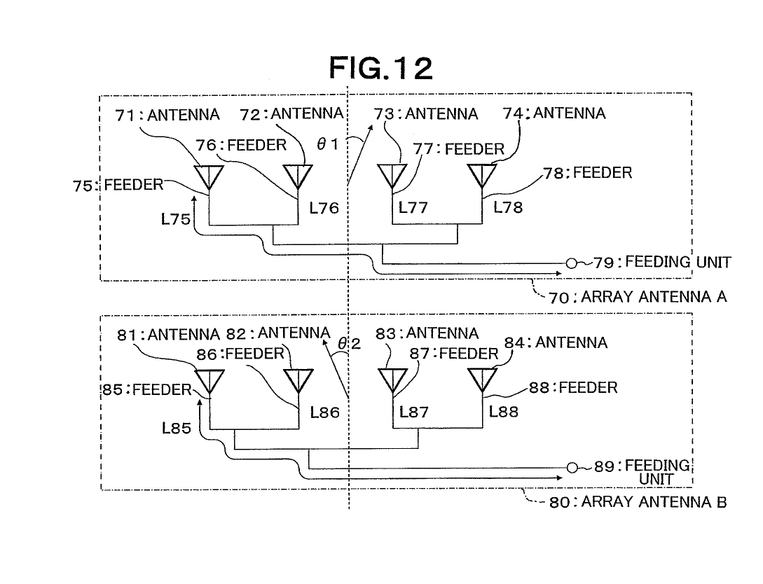

FIG. 12 is a configuration diagram of a multibeam antenna according to a tenth embodiment of the present invention. In principle, it may be understood that the idea of FIG. 1 is extended from two elements to four elements. An array antenna A 70 is configured to include antennas 71 to 74 and feeders 75 to 78 having lengths of L75 to L78, respectively. Likewise, an array antenna B 80 is configured to include antennas 81 to 84 and feeders 85 to 88 having lengths of L85 to L88, respectively. The lengths L75 to L78 and L85 to L88 of the feeders are designed so that maximum radiation directions of combined directivities are oriented to a θ1 direction and a θ2 direction according to the principle of the Equations (1) and (2) and the Equations (5) and (6), respectively. If values calculated similarly to the Equations (1) to (10) are given to a phase relationship for feeding power from feeding units 79 and 89, radiation patterns are formed on a horizontal plane so that a first null angle of the other pattern is an angle of a beam peak of one pattern similarly to FIG. 6B.

FIG. 12 shows the instance of extending the two elements to the four elements. Alternatively, a similar principle may be applied to an instance so that a maximum radiation direction of a beam radiated from an array antenna of an M1 element is set to a direction of (θ1, φ1), and so that a maximum radiation direction of a combined beam from an array antenna of a second M2 element is oriented to a direction of an arbitrary first null point (θ2, φ2) near (θ1, φ1). In this case, M1 may be equal to M2, i.e., M1-M2. It is, however, necessary that both M1 and M2 are equal to or greater than 2.

Likewise, the above-stated principle can be applied to two-dimensional array antennas. Namely, the principle can be applied to the two-dimensional array antennas so that a maximum radiation direction of a beam radiated from an array antenna of an M1×N1 element is set to a direction of (θ1, φ1), and so that a maximum radiation direction of a combined beam from an array antenna of a second M2×N2 element is oriented to a direction of an arbitrary first null point (θ2, φ2) near (θ1, φ1). In this case, M1 may be equal to M2, i.e., M1=M2 and N1 may be equal to N2, i.e., N1=N2. Namely, values of M1, M2, N1, and N2 are not limited to specific values. However, in this case, it is necessary that one of M1 and M2 is equal to or greater than 2 and that one of N1 and N2 is equal to or greater than 2.

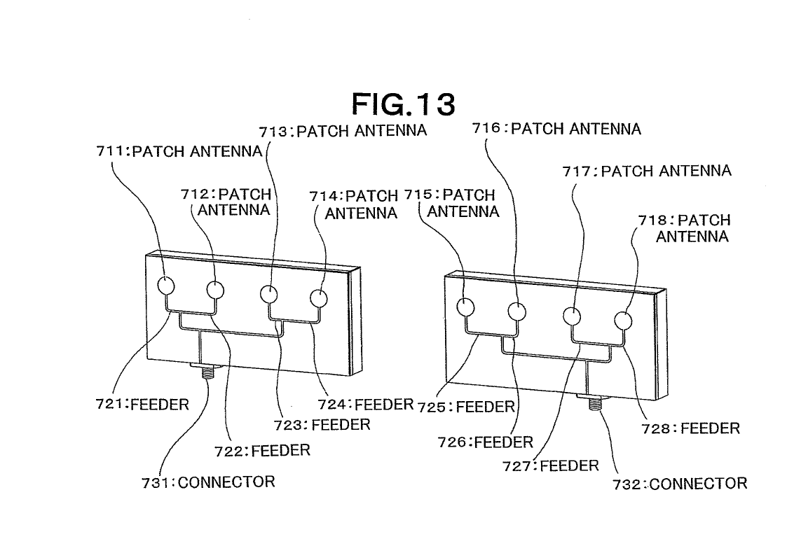

FIG. 13 is a configuration diagram of a multibeam antenna according to an eleventh embodiment of the present invention. The multibeam antenna shown in FIG. 13 is obtained by specifically embodying the configuration shown in FIG. 12 to FIG. 13 to imitate the relationship of FIGS. 1 and 5. According to the explanation with reference to FIG. 12, if power is fed from connectors 731 and 732 while giving a desired phase difference, radiation patterns are formed on a horizontal plane so that a first null angle of the other pattern is an angle of a beam peak of one pattern similarly to FIG. 6B.

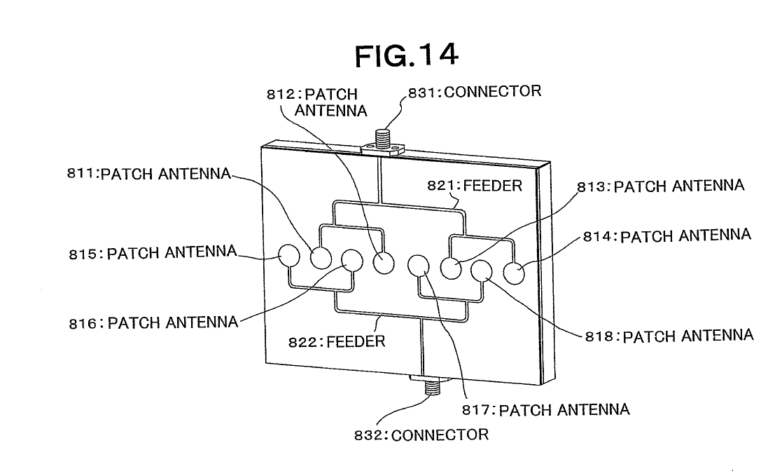

FIG. 14 is a configuration diagram of a multibeam antenna according to a twelfth embodiment of the present invention. Power is fed to patch antennas 811 to 814 in parallel by a feeder 821 and the patch antennas 811 to 814 reach a connector 831. Likewise, power is fed to patch antennas 815 to 818 in parallel by a feeder 822 and the patch antennas 815 to 818 reach a connector 832. It can be understood that the multibeam antenna shown in FIG. 14 is structured so that portions of the patch antennas of the two array antennas shown in FIG. 13 are inserted alternately. By arranging the patch antennas alternately, the multibeam antenna can be configured to have a slim structure. Similarly to FIG. 13, power is fed to the connectors 831 and 832 independently of each other.

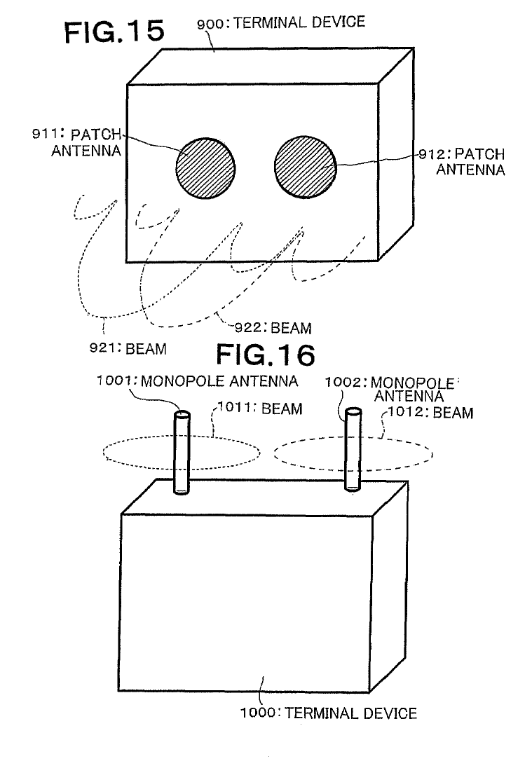

FIG. 15 is a configuration diagram of a multibeam antenna according to a thirteenth embodiment of the present invention. Patch antennas 911 and 912 are arranged on one of panels of a terminal device 900 and power is fed similarly to FIGS. 1 and 6B. It is thereby possible to form radiation patterns so that a first null angle of the other pattern is an angle of a beam peak of one pattern as indicated by beams 921 and 922 (similarly to the radiation patterns shown in FIG. 6B). Such radiation patterns have low correlation to each other and are quite effective for accelerating transmission rate and improving transmission quality in communication using the MIMO technique.

The number of patch antennas arranged on the panel surface of the terminal device 900 is not limited to two but a similar advantage can be obtained even by arranging the antennas shown in FIG. 12 or 13.

The present application is based on Japanese Patent Application No. 2007-103021 (filed on Apr. 10, 2007) and claims priority of the Paris Convention based on the Japanese Patent Application No. 2007-103021. A disclosed content of the Japanese Patent Application No. 2007-103021 is incorporated in the present specification by reference to the Japanese Patent Application No. 2007-103021.

The typical embodiments of the present invention have been described in detail. However, it is to be understood that various changes, substitutions and alternatives can be made without departure of the spirit and scope of the invention defined by claims. Moreover, even if the claims are amended in application procedures, the inventor intend to maintain an equivalent range of the claimed invention.

### INDUSTRIAL APPLICABILITY

The present invention can be used for a base station antenna, a terminal antenna or the like using WiMAX technique or MIMO technique.

1. A multibeam antenna comprising:
a first array antenna; and
a second array antenna,
wherein the first array antenna and the second array antenna have directivities different in direction, respectively,
a maximum radiation direction of a combined beam from the first array antenna is oriented to a direction of θ1, and
a maximum radiation direction of a combined beam from the second array antenna is oriented to a direction of θ2 corresponding to a null point of the combined beam from the first array antenna.

2. The multibeam antenna according to claim 1,
wherein a maximum radiation direction of the combined beam from the first array antenna for providing a maximum gain is set to a direction of (θ1, φ1) on polar coordinates, and the maximum radiation direction of the combined beam from the second array antenna is oriented to a direction of an arbitrary first null point (θ2, φ2) near the (θ1, φ1).

3. The multibeam antenna according to claim 1,
wherein a null point of the second array antenna is present in the direction of the (θ1, φ1) on the polar coordinates.

4. The multibeam antenna according to claim 1,
wherein the first array antenna is an array antenna having an antenna of an M element arranged on a Z axis of the polar coordinates, and the second array antenna is an array antenna having an antenna of an M element or N element (MEN) arranged on the Z axis of the polar coordinates or on a line parallel to the Z axis.

5. The multibeam antenna according to claim 1,
wherein the first antenna is an array antenna having antennas of two elements arranged on a Z axis of the polar coordinates, and the second array antenna is an array antenna having antennas of two elements arranged on the Z axis of the polar coordinates or on a line parallel to the Z axis.

6. The multibeam antenna according to claim 1,
wherein the first antenna is an array antenna having two elements, the second array antenna is an array antenna having two elements, the first array antenna and the second array antenna have directivities for providing maximum gains in different directions from each other, respectively, a distance between the two elements of the first array antenna is equal to a distance between the two elements of the second array antenna, and a line connecting the two elements of the first array antenna and a line connecting the two elements of the second array antenna have an identical relationship or a parallel relationship.

7. The multibeam antenna according to claim 6,
wherein if a normalized element distance is assumed as D (D=d/λ, where λ is a wavelength, if an element distance is d) and θ1 >θ2, a relationship among the θ1, the θ2, and the d is expressed as
sin{(θ1−θ2)/2}=1/(4D).

8. The multibeam antenna according to claim 6,
wherein power is fed to the two elements of the first array antenna 1 in same phase, power is fed to the two elements of the second array antenna in the same phase,
the maximum radiation direction of the first array antenna shifts from a perpendicular direction of a line of the array (a broadside direction of the array) by a θ1 degrees on a plane including the line, and the maximum radiation direction of the second array antenna similarly shifts from a perpendicular direction of a line of the array (a broadside direction of the array) by a −θ1 degrees on a plane including the line,
the maximum radiation direction −θ1 of the second array antenna is a null direction of the first array antenna, and
the maximum radiation direction θ1 of the first array antenna is a null direction of the second array antenna.

9. The multibeam antenna according to claim 1,
wherein a phase difference between power feeding to the first array antenna and power feeding to the second array antenna is π/2.
